(19) United States
(12) Patent Application Publication
(10) Pub. No.: US 2012/0190765 A1
(43) Pub. Date: Jul. 26, 2012

(54) ROBUST CURABLE SOLID INKS

(75) Inventors: Naveen Chopra, Oakville (CA); Michelle Chretien, Mississauga (CA); Barkev Keoshkerian, Thornhill (CA); Daryl W. Vanbesien, Burlington (CA); Valerie M. Farrugia, Oakville (CA)

(73) Assignee: XEROX CORPORATION, Norwalk, CT (US)

(21) Appl. No.: 13/010,696

(22) Filed: Jan. 20, 2011

(51) Int. Cl. C08J 7/18; C08F 2/50

(52) U.S. Cl. 522/33; 522/78; 522/64

(57) ABSTRACT

Curable solid inks which are solid at room temperature and molten at an elevated temperature at which the molten ink is applied to a substrate. In particular, the curable solid inks of the present embodiments retain the advantages of handling, safety, and print quality usually associated with conventional curable solid phase change inks but have replaced the petroleum-based materials generally used in the conventional inks with renewable “green” materials to provide a robust and environmentally-friendly curable solid ink.

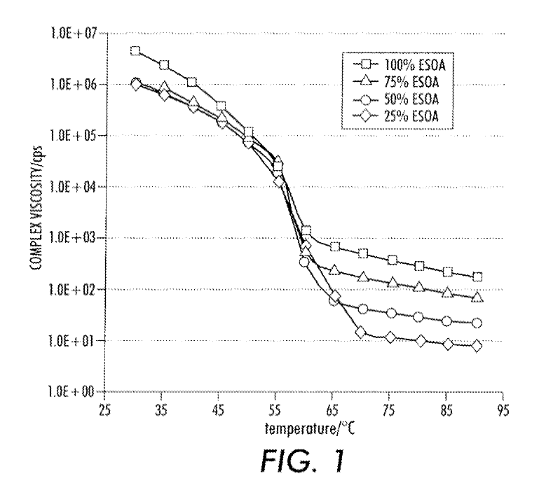

### BACKGROUND

The present embodiments relate to solid phase change ink compositions characterized by being solid at room temperature and molten at an elevated temperature at which the molten ink is applied to a substrate. These solid ink compositions can be used for ink jet printing in a variety of applications. The present embodiments are directed to curable solid inks (CSI), and in particular, the curable solid ink is an ultraviolet (UV) curable ink with robust characteristics. In addition to providing desirable ink qualities, the present embodiments are based on renewable “green” materials which help reduce the carbon footprint of these inks.

Ink jet printing processes generally may employ inks that are solid at room temperature and liquid at elevated temperatures. Such inks may be referred to as solid inks, hot melt inks, phase change inks and the like. For example, U.S. Pat. No. 4,490,731, the disclosure of which is totally incorporated herein by reference, discloses an apparatus for dispensing solid ink for printing on a recording medium such as paper. In thermal ink jet printing processes employing hot melt inks, the solid ink is melted by the heater in the printing apparatus and utilized (jetted) as a liquid in a manner similar to that of conventional thermal ink jet printing. Upon contact with the printing recording medium, the molten ink solidifies rapidly, allowing the colorant to substantially remain on the surface of the recording medium instead of being carried into the recording medium (for example, paper) by capillary action, thereby enabling higher print density than is generally obtained with liquid inks. Advantages of a solid ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

Solid inks are desirable for ink jet printers because they remain in a solid phase at room temperature during shipping, long term storage, and the like. In addition, the problems associated with nozzle clogging as a result of ink evaporation with liquid ink jet inks are largely eliminated, thereby improving the reliability of the ink jet printing. Further, in solid ink jet printers wherein the ink droplets are applied directly onto the final recording medium (for example, paper, transparency material, and the like), the droplets solidify immediately upon contact with the recording medium, so that migration of ink along the printing medium is prevented and dot quality is improved.

Curable solid inks were conceived as a means to use conventional solid ink print process, especially transfix, and deliver an increase in mechanical robustness after curing. One of the challenges in formulating a suitable curable solid ink is to create a solid ink with sufficient molecular mobility to allow rapid and extensive curing. In addition to achieving formulations that will provide solid inks with such characteristics, there has been a recent drive to create formulations that are derived from renewable “green” materials to reduce the carbon footprint of the inks. For example, one focus has been on sourcing sustainable monomers derived from biomaterials. The conventional monomer, which is a major component of the ink (e.g., typically from about 50 to about 55 percent by weight of the total weight of the ink), is generally a diacrylate molecule derived from petroleum-based diols. By identifying and using renewable biomaterials to replace the petroleum-based materials, dependence on fossil fuels can be reduced while providing environmentally-friendly inks.

Thus, while the disclosed solid ink formulation provides some advantages over the prior formulations, there is still a need to achieve a formulation that not only provides the desirable properties of a curable solid ink but is also derived from renewable resources, such as plants.

### SUMMARY

According to embodiments illustrated herein, there is provided novel curable solid ink compositions comprising monomer materials made from non-fossil fuel feedstocks suitable for ink jet printing.

In particular, the present embodiments provide a curable solid ink comprising: a curable wax; one or more monomers; an amide gellant; a photoinitiator; and an optional colorant, wherein the one or more monomers comprises a product of a reaction where an unsaturated oil having one or more epoxy groups has been functionalized by acrylic acid.

In further embodiments, there is provided a curable solid ink comprising: a curable wax; one or more monomers; an amide gellant; a photoinitiator; and an optional colorant, wherein the one or more monomers comprises an epoxidized compound being selected from the group consisting of:

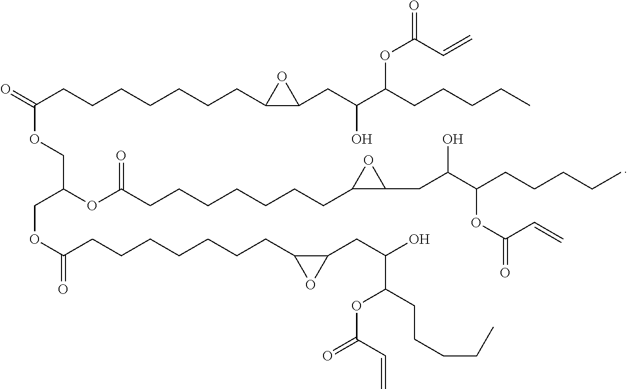

In yet other embodiments, there is provided a curable solid ink comprising: a curable wax; one or more monomers; an amide gellant; a photoinitiator; and an optional colorant, wherein the one or more monomers comprises an epoxidized oil acrylate obtained from a reaction of an epoxidized oil with acrylic acid such that some or all of the epoxide groups are ring-opened and acrylate groups are incorporated into the backbone structure.

### BRIEF DESCRIPTION OF THE DRAWINGS

For a better understanding of the present embodiments, reference may be had to the accompanying FIGURE.

The FIGURE is a graph illustrating complex viscosity versus temperature of solid inks made according to the present embodiments.

### DETAILED DESCRIPTION

In the following description, it is understood that other embodiments may be utilized and structural and operational changes may be made without departure from the scope of the present embodiments disclosed herein.

Solid ink technology broadens printing capability and customer base across many markets, and the diversity of printing applications will be facilitated by effective integration of printhead technology, print process and ink materials. The solid ink compositions are characterized by being solid at room temperature and molten at an elevated temperature at which the molten ink is applied to a substrate. As discussed above, while current ink options are successful for printing on various substrates, there is still a need to achieve curable solid inks that provide increased curing speed and enhanced robustness and hardness upon curing.

The present embodiments are directed generally to ultraviolet (UV) curable solid inks. In particular, the present embodiments provide curable solid inks that demonstrate desirable properties, such as robustness, for use in inkjet-based print applications and are based on renewable biomaterials. Thus, the solid inks of the present embodiments retain the advantages of handling, safety, and print quality usually associated with solid phase change inks but provide additional benefit of being comprised mostly of sustainable materials. For example, in the present embodiments, the petroleum-based monomers are replaced with epoxidized soy oil acrylates (ESOA), which are bio-based materials derived from plant sources such as linseeds and soybeans or from animal sources such as castor oil. The multifunctional properties of these bio-based acrylates can also offer high levels of crosslinking to create more robust inks and allow for a “green” replacement of existing multifunctional acrylates, such as, SR399LV, a low viscosity dipentaerythritol pentaacrylate available from Sartomer Company (Exton, Pa.).

The present embodiments comprise blends of curable waxes, monomers, curable gellants, free-radical photoinitiators, crosslinkers and optional colorants. In the present embodiments, the monomers comprise a product of an unsaturated oil containing one or more epoxy groups that has been functionalized by acrylic acid. In specific embodiments, the product of this reaction are epoxidized oil acrylates. For example, those that are naturally occurring plant/seed oils that have been chemically modified to create acrylate functional groups. The double bonds of the oils are epoxidized using peracetic acid followed by reaction with acrylic acid to attach acrylate groups where the double bonds were originally situated. The transformations of the oils are shown by an exemplary two-step reaction below:

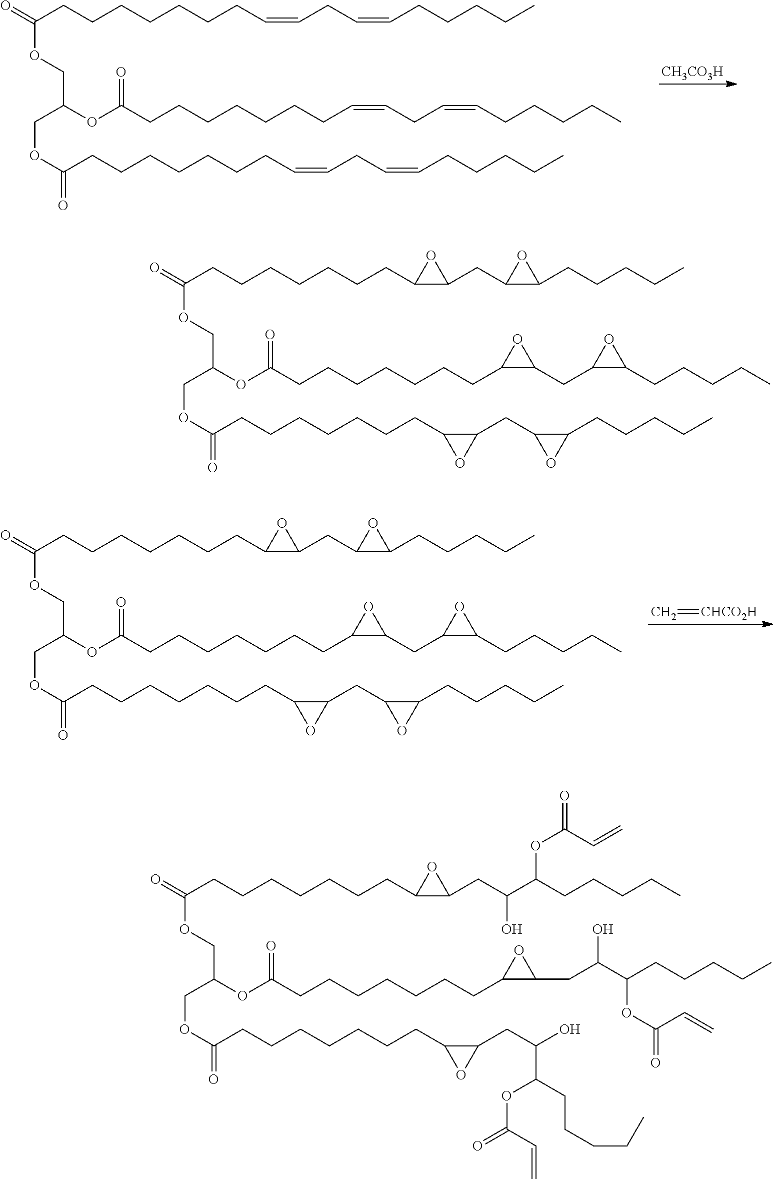

As can be seen in the above reaction schemes, the epoxidized oil acrylate is obtained from a reaction of an epoxidized oil with acrylic acid such that some or all of the epoxide groups are ring-opened and acrylate groups are incorporated into the backbone structure.

Recent methods have been disclosed that also use Ti/SO₂ catalysts and hydrogen peroxide to obtain epoxidized compounds as shown below (from http://pubs.rsc.org/en/Content/ArticleLanding/2004/GC/b404975f):

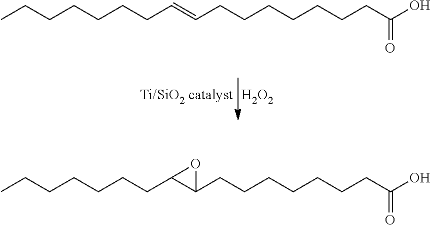

In further embodiments, the monomer is selected from the group consisting of is selected from the group consisting of epoxidized soybean oil acrylate, epoxidized castor oil acrylate, epoxidized linseed oil acrylate, epoxidized rapeseed oil acrylate, and mixtures thereof. In specific embodiments, the monomer may also be a castor oil acrylate. In these embodiments, the epoxidized oil acrylate may be used for all or part of the monomers present in the solid inks. In the present embodiments, the epoxidized oil acrylates are present in the solid ink in an amount of from about 1 to about 25 percent by weight of the total weight of the ink. In other embodiments, the epoxidized oil acrylates are present in the solid ink in an amount of from about 2 to about 20 percent, or of from about 5 to about 10 percent, by weight of the total weight of the ink

In embodiments, there is generally provided curable solid inks comprising a curable wax, one or more monomers, an optional colorant, an amide gellant, and a photoinitiator, wherein the one or more monomers comprises an epoxidized oil acrylate. In embodiments, the compounds disclosed herein are curable. “Curable” as used herein means polymerizable or chain extendable, that is, a material that can be cured via polymerization, including, but not limited to, free radical polymerization or chain extension, cationic polymerization or chain extension, and/or in which polymerization is photoinitiated through use of a radiation sensitive photoinitiator. Radiation curable as used herein is intended to cover all forms of curing upon exposure to a radiation source, including, but not limited to, light and heat sources and including in the presence or absence of initiators. Examples of radiation curing include, but are not limited to, ultraviolet (UV) light, for example having a wavelength of from about 200 to about 400 nanometers, visible light, or the like, optionally in the presence of photoinitiators and/or sensitizers, electron-beam radiation, optionally in the presence photoinitiators, thermal curing, optionally in the presence of high temperature thermal initiators (and which are in selected embodiments largely inactive at the jetting temperature when used in phase change inks), and appropriate combinations thereof.

In general embodiments, the curable wax is present in an amount of from about 1 to about 25 percent by weight of the total weight of the curable solid ink. The wax may be selected from the group consisting of Unilin 350 acrylate, behenyl acrylate, octadecyl acrylate, acrylated C₁₂ linear alcohols, and the like, and mixtures thereof.

The optional colorant may be present in the curable ink in any desired or effective amount to obtain the desired color or hue such as, for example, at least from about 0.1 percent by weight of the ink to about 50 percent by weight of the ink, at least from about 0.2 percent by weight of the ink to about 20 percent by weight of the ink, and at least from about 0.5 percent by weight of the ink to about 10 percent by weight of the ink. In specific embodiments, the optional colorant is present in an amount of from about 15 to about 25 percent by weight of the total weight of the curable solid ink. The optional colorant may be selected from the group consisting of a pigment, dye or mixtures thereof. In a specific embodiment, the optional colorant comprises a dispersion of cyan pigment in a propoxylated neopentyl glycol diacrylate.

In general embodiments, the gellant is an amide gellant and the like, and is present in an amount of from about 2 to about 25 percent or from about 4 to about 12 by weight of the total weight of the curable ink. In general embodiments, the photoinitiator is present in an amount of from about 1 to about 15 percent or from about 6 to about 15 by weight of the total weight of the curable solid ink.

The photoinitiator may be selected from the group consisting of alpha-hydroxy ketones, mono-acyl phosphine oxides, bis-acyl phosphine oxides, and the like, and mixtures thereof.

In the present embodiments, there is further provided a method of using the curable solid ink for jet printing text. In such embodiments, the method comprises jetting a curable solid ink onto an intermediate substrate to form an intermediate image, transferring the intermediate image onto a substrate to form a transferred image, and exposing the transferred image to radiation having wavelengths in the range of from about 4 nanometers to about 500 nanometers to cure the curable solid ink. In embodiments, the jetting step is performed at above 70° C., or at from about 70 to about 100° C.

Any suitable printing device may used herein. In one embodiment, the apparatus is an ink jet printing device as described in commonly assigned, co-pending U.S. Patent Publication No. 2008/0218540, incorporated by reference in its entirety, that includes at least an ink jet print head and a print region surface toward which ink is jetted from the ink jet print head, wherein a height distance between the ink jet print head and the print region surface is adjustable.

The apparatus, as well as the methods herein, may be employed with any desired printing system and marking material suitable for applying a marking material in an imagewise pattern to an intermediate transfer member or directly to an image receiving substrate, such as thermal ink jet printing (both with inks liquid at room temperature and with phase change inks), piezoelectric ink jet printing (both with inks liquid at room temperature and with phase change inks), acoustic ink jet printing (both with inks liquid at room temperature and with phase change inks), thermal transfer printing, gravure printing, electrostatographic printing methods (both those employing dry marking materials and those employing liquid marking materials), and the like. For the purpose of illustration, a piezoelectric phase change ink jet printer for applying marking material in an imagewise pattern to an intermediate transfer member is described.

Radiation curable inks generally comprise at least one curable monomer, a gellant, a colorant, and a radiation activated initiator, specifically a photo initiator, that initiates polymerization of curable components of the ink, specifically of the curable monomer. U.S. Pat. No. 7,279,587 to Odell et al., the disclosure of which is totally incorporated herein by reference, discloses photoinitiating compounds useful in curable solid ink compositions. U.S. Patent Publication 2007/0120910 to Odell et al., which is hereby incorporated by reference herein in its entirety, describes, in embodiments, a solid ink comprising a colorant, an initiator, and an ink vehicle.

In some embodiments, the one or more monomers further comprise monomers other than epoxidized oil acrylate, such as for example, propoxylated neopentyl glycol diacrylate. In specific embodiments, the ink vehicles disclosed herein can comprise any suitable curable monomer or prepolymer. Examples of suitable materials include radically curable monomer compounds, such as acrylate and methacrylate monomer compounds, which are suitable for use as phase change ink carriers. In addition, multifunctional acrylate and methacrylate monomers and oligomers can be included in the phase change ink carrier.

Suitable radiation, such as UV, curable monomers and oligomers include, for example, acrylated esters, acrylated polyesters, acrylated ethers, acrylated polyethers, acrylated epoxies, urethane acrylates, and pentaerythritol tetraacrylate. Specific examples of suitable acrylated monomers include monoacrylates, diacrylates, and polyfunctional alkoxylated or polyalkoxylated acrylic monomers comprising one or more di- or tri-acrylates. Suitable monoacrylates are, for example, cyclohexyl acrylate, 2-ethoxy ethyl acrylate, 2-methoxy ethyl acrylate, 2-(2-ethoxyethoxy) ethyl acrylate, stearyl acrylate, tetrahydrofurfuryl acrylate, octyl acrylate, lauryl acrylate, behenyl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate. ethoxylated phenol monoacrylate, oxyethylated phenol acrylate, monomethoxy hexanediol acrylate, beta-carboxy ethyl acrylate, dicyclopentyl acrylate, carbonyl acrylate, octyl decyl acrylate; ethoxylated nonylphenol acrylate, hydroxyethyl acrylate, hydroxyethyl methacrylate, tricyclodecane dimethanol diacrylate, dioxane glycol diacrylate, and the like. Suitable polyfunctional alkoxylated or polyalkoxylated acrylates are, for example, alkoxylated, such as ethoxylated or propoxylated, variants of the following: neopentyl glycol diacrylates, butanediol diacrylates, trimethylolpropane triacrylates, glyceryl triacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, polybutanediol diacrylate, polyethylene glycol diacrylate, propoxylated neopentyl glycol diacrylate, ethoxylated neopentyl glycol diacrylate, polybutadiene diacrylate, and the like.

A suitable monomer is a propoxylated neopentyl glycol diacrylate, such as, for example, SR9003 (Sartomer Co., Inc., Exton, Pa.). Other suitable reactive monomers are likewise commercially available from, for example, Sartomer Co., Inc., Henkel Corp., Radcure Specialties, and the like. Specific examples of suitable acrylated oligomers include, for example, acrylated polyester oligomers, such as CN2262 (Sartomer Co.), EB 812 (Cytec Surface Specialties), EB 810 (Cytec Surface Specialties), CN2200 (Sartomer Co.), CN2300 (Sartomer Co.), and the like, acrylated urethane oligomers, such as EB270 (UCB Chemicals), EB 5129 (Cytec Surface Specialties), CN2920 (Sartomer Co.), CN3211 (Sartomer Co.), and the like, and acrylated epoxy oligomers, such as EB 600 (Cytec Surface Specialties), EB 3411 (Cytec Surface Specialties), CN2204 (Sartomer Co.), CN110 (Sartomer Co.), and the like; and pentaerythritol tetraacrylate oligomers, such as SR399LV (Sartomer Co.) and the like.

These monomers and oligomers function as reactive diluents and as materials that can increase the crosslink density of the cured image, thereby enhancing the toughness of the cured image. When a reactive diluent is added to the ink carrier material, the reactive diluent is added in any desired or effective amount, for example, from about 1 percent to about 80 percent by weight of the carrier, or from about 35 percent to about 70 percent by weight of the carrier, although the amount of diluent can be outside of these ranges.

In specific embodiments, the ink vehicles disclosed herein can comprise any suitable photoinitiator. Examples of specific initiators include, but are not limited to, IRGACURE® 127, IRGACURE® 379, and IRGACURE® 819, all commercially available from BASF Chemicals, among others. Further examples of suitable initiators include (but are not limited to) benzophenones, benzophenone derivatives, benzyl ketones, α-alkoxy benzyl ketones, monomeric hydroxyl ketones, polymeric hydroxyl ketones, α-amino ketones, alkoxy ketones, acyl phosphine oxides, metallocenes, benzoin ethers, benzil ketals, α-hydroxyalkylphenones, α-aminoalkylphenones, acyiphosphine photoinitiators sold under the trade designations of IRGACURE® and DAROCUR® from BASF, and the like. Specific examples include 1-hydroxy-cyclohexylphenylketone, benzophenone, 2-benzyl-2-(dimethylamino)-1-(4-(4-morphorlinyl)phenyl)-1-butanone, 2-methyl-1-(4-methylthio)phenyl-2-(4-morphorlinyl)-1-propanone, diphenyl-(2,4,6-trimethylbenzoyl) phosphine oxide, phenyl bis(2,4,6-trimethylbenzoyl)phosphine oxide, benzyl-dimethylketal, isopropylthioxanthone, 2,4,6-trimethylbenzoyldiphenylphosphine oxide. (available as BASF LUCIRIN® TPO), 2,4,6-trimethylbenzoylethoxyphenylphosphine oxide (available as BASF LUCIRIN® TPO-L), bis(2,4,6-trimethylbenzoyl)-phenyl-phosphine oxide (available as BASF IRGACURE® 819) and other acyl phosphines, 2-methyl-1-(4-methylthio)phenyl-2-(4-morphorlinyl)-1-propanone (available as BASF IRGACURE® 907) and 1-(4-(2-hydroxyethoxy)phenyl)-2-hydroxy-2-methylpropan-1-one (available as BASF IRGACURE® 2959), 2-benzyl 2-dimethylaminol-(4-morpholinophenyl)butanone-1(available as BASF IRGACURE® 369), 2-hydroxy-1-(4-(4-(2-hydroxy-2-methylpropionyl)-benzyl)-phenyl-2-methylpropan-1-one (available as BASF IRGACURE® 127), 2-dimethylamino-2-(4-methylbenzyl)-1-(4-morpholin-4-ylphenyl)-butanone (available as BASF IRGACURE® 379), titanocenes, isopropylthioxanthone, 1-hydroxy-cyclohexylphenylketone, benzophenone, 2,4,6-trimethylbenzophenone, 4-methylbenzophenone, diphenyl-(2,4,6-trimethylbenzoyl) phosphine oxide, 2,4,6-trimethylbenzoylphenylphosphinic acid ethyl ester, oligo(2-hydroxy-2-methyl-1-(4-(1-methylvinyl)phenyl) propanone), 2-hydroxy-2-methyl-1-phenyl-1-propanone, benzyl-dimethylketal, arylsulphonium slats, aryl iodonium salt, and the like, as well as mixtures thereof.

Optionally, the phase change inks can also contain an amine synergist, which are co-initiators which can donate a hydrogen atom to a photoinitiator and thereby form a radical species that initiates polymerization, and can also consume dissolved oxygen, which inhibits free-radical polymerization, thereby increasing the speed of polymerization. Examples of suitable amine synergists include (but are not limited to) ethyl-4-dimethylaminobenzoate, 2-ethylhexyl-4-dimethylaminobenzoate, and the like, as well as mixtures thereof.

Initiators for inks disclosed herein can absorb radiation at any desired or effective wavelength, for example, from about 4 nanometers to about 560 nanometers, or from about 200 nanometers to about 560 nanometers, or from about 200 nanometers to about 420 nanometers, although the wavelength can be outside of these ranges.

Optionally, the photoinitiator is present in the phase change ink in any desired or effective amount, for example from about 0.5 percent to about 15 percent by weight of the ink composition, or from about 1 percent to about 10 percent by weight of the ink composition, although the amount can be outside of these ranges.

The ink vehicles contain at least one compound that can exhibit gel-like behavior in that they undergo a relatively sharp increase in viscosity over a relatively narrow temperature range when dissolved in a liquid such as those compounds that behave as curable monomers when exposed to radiation such as ultraviolet light. One example of such a curable liquid monomer is a propoxylated neopentyl glycol diacrylate. In one embodiment, some vehicles as disclosed herein undergo a change in viscosity of at least about 10³ centipoise, in another embodiment at least about 10⁵ centipoise, and in yet another embodiment at least about 10⁶ centipoise over a temperature range of in one embodiment at least about 30° C. in another embodiment at least about 10° C., and in vet another embodiment at least about 5° C., although the viscosity change and temperature range can be outside of these ranges, and vehicles that do not undergo changes within these ranges are also included herein.

Any suitable gellant can be used for the ink vehicles disclosed herein. The gellant can be selected from materials disclosed in U.S. Pat. No. 7,279,687, entitled “Photoinitiator With Phase Change Properties and Gellant Affinity,” with the named inventors Peter G. Odell, Eniko Toma, and Jennifer L. Belelie, the disclosure of which is totally incorporated herein by reference, such as a compound of the formula

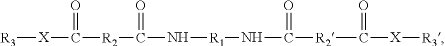

wherein R₁ is: (i) an alkylene group (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphors, boron, and the like either may or may not be present in the alkylene group), in one embodiment with from about 1 to about 12 carbons, or from about 2 to about 4 carbons,

(ii) an arylene group (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), in one embodiment from about 5 to about 14 carbons or from about 6 to about 10 carbon atoms,

(iii) an arylalkylene group (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), in one embodiment from about 6 to about 32 carbons, or from about 7 to about 22 carbon atoms, or

(iv) an alkylarylene group (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with from about 7 to about 32 carbons or from about 7 to about 22 carbon atoms, wherein the substituents on the substituted alkylene, arylene, arylalkylene, and alkylarylene groups can be (but are not limited to) halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ and R_{2′}each, independently of the other, are selected from the group consisting of:

(i) alkylene groups (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), in one embodiment with from 1 to about 54 carbons or from about 1 to about 34 carbon atom,

(ii) arylene groups (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), in one embodiment with at least about 5 carbon atoms, and in another embodiment with from about 6 to about 14 carbons or from about 7 to about 10 carbon atoms,

(iii) arylalkylene groups (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), in one embodiment with from about 6 to about 32 carbons, or from about 7 to about 22 carbon atoms, or

(iv) alkylarylene groups (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with from about 7 to about 32 carbon atoms or from about 7 to about 22 carbon atoms, wherein the substituents on the substituted alkylene, arylene, arylalkylene, and alkylarylene groups can be (but are not limited to) halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring;

R₃ and R_{3′}. each, independently of the other, are either:

(a) photoinitiating groups, such as groups derived from 1-(4-(2-hydroxyethoxy)phenyl)-2-hydroxy-2-methylpropan-1-one, of the formula

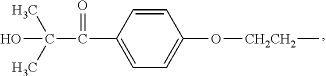

groups derived from 1-hydroxycyclohexylphenylketone, of the formula

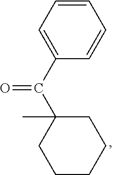

groups derived from 2-hydroxy-2-methyl-1-phenylpropan-1-one, of the formula

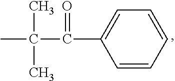

groups derived from N,N-dimethylethanolamine or N,N-dimethylethylenediamine, of the formula

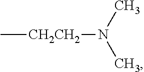

or the like, or:

(b) a group which is:

(i) an alkyl group (including linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may or may not be present in the alkyl group), in one embodiment from about 2 to about 100 or from about 3 to about 60 or from about 4 to about 30 carbon atoms, although the number of carbon atoms can be outside of these ranges,

(ii) an aryl group (including substituted and unsubstituted aryl groups, and wherein heteroatoms, such as oxygen, nitrogen, sulfur, silicon, phosphorus, boron, and the like either may or may not be present in the aryl group), in one embodiment from about 5 to about 100 or from about 6 to about 60 or from about 6 to about 30 carbon atoms, such as phenyl or the like,

(iii) an arylalkyl group (including substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkyl group), in or embodiment with at least about 6 carbon atoms, and in another embodiment with from about 7 to about 100 or from about 7 to about 60 carbon atoms, although the number of carbon atoms can be outside of these ranges, such as benzyl or the like, or

(iv) an alkylaryl group (including substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylaryl group), in one embodiment from about 6 to about 100 or from about 7 to about 60 or from about 7 to about 30 carbon atoms, such as tolyl or the like, wherein the substituents on the substituted alkyl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrite groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring: provided that X and X′ each, independently of the other, is an oxygen atom or a group of the formula —NR₄—, wherein R₄ is:

(i) a hydrogen atom,

(ii) an alkyl group, including linear and branched, saturated and unsaturated, cyclic and acyclic, and substituted and unsubstituted alkyl groups, and wherein heteroatoms either may or may not be present in the alkyl group, in one embodiment with from about 1 to about 100 or from about 1 to about 60 or from about 1 to about 30 carbon atoms,

(iii) an aryl group, including substituted and unsubstituted aryl groups, and wherein heteroatoms either may or may not be present in the aryl group, in one embodiment with from about 5 to about 100 or from about 6 to about 60 carbon atoms, although the number of carbon atoms can be outside of these ranges,

(iv) an arylalkyl group, including substituted and unsubstituted arylalkyl groups, wherein the alkyl portion of the arylalkyl group can be linear or branched, saturated or unsaturated, and cyclic or acyclic, and wherein heteroatoms either may or may not be present in either the aryl or the alkyl portion of the arylalkyl group, in one embodiment with from about 6 to about 100 or from about 7 to about 60 carbon atoms, although the number of carbon atoms can be outside of these ranges, or

(v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, in one embodiment with from about 6 to about 100 or from about 7 to about 60 carbon atoms, wherein the substituents on the substituted alkyl, aryl, arylalkyl, and alkylaryl groups can be (but are not limited to) halogen atoms, ether groups, aldehyde groups, ketone groups, ester groups. amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups. isocyanato groups, thiocyanato groups, isothiocyanato groups, carboxylate groups, carboxylic acid groups, urethane groups, urea groups, mixtures thereof, and the like, wherein two or more substituents can be joined together to form a ring. In embodiments, the radiation curable phase change in herein comprises a gellant as described above and optionally a curable wax.

In embodiments, the gelling agent or gellant is a mixture of amide gelling agents of the general structures

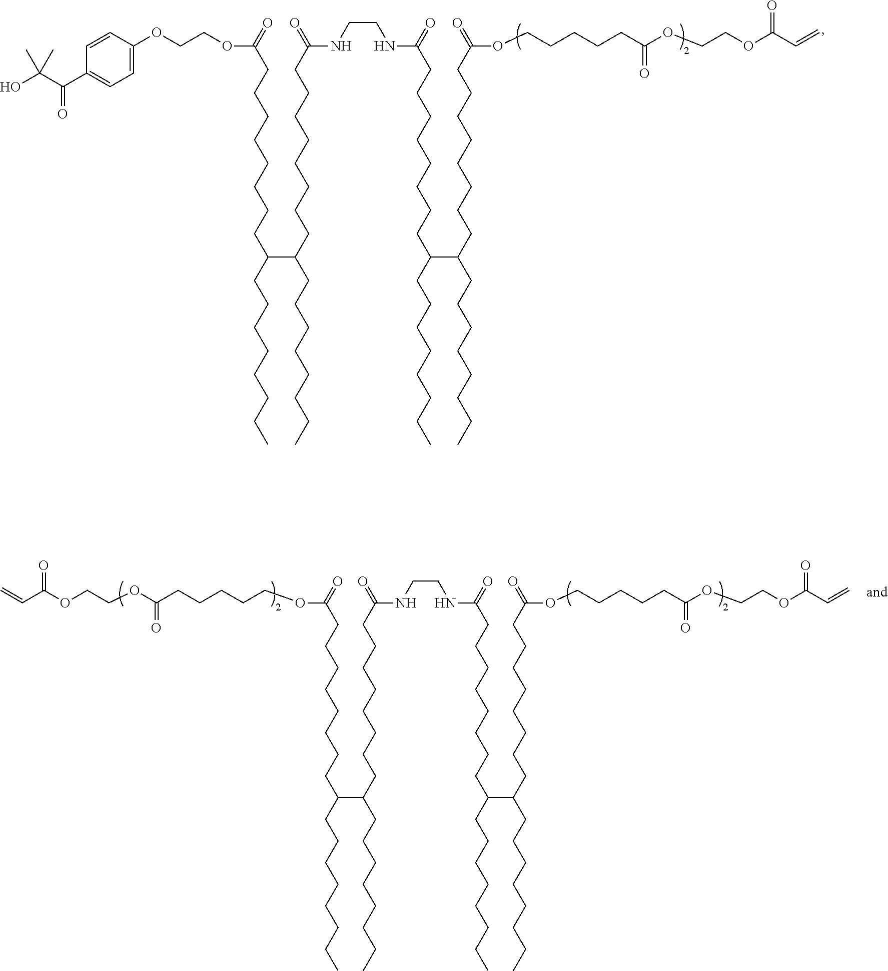

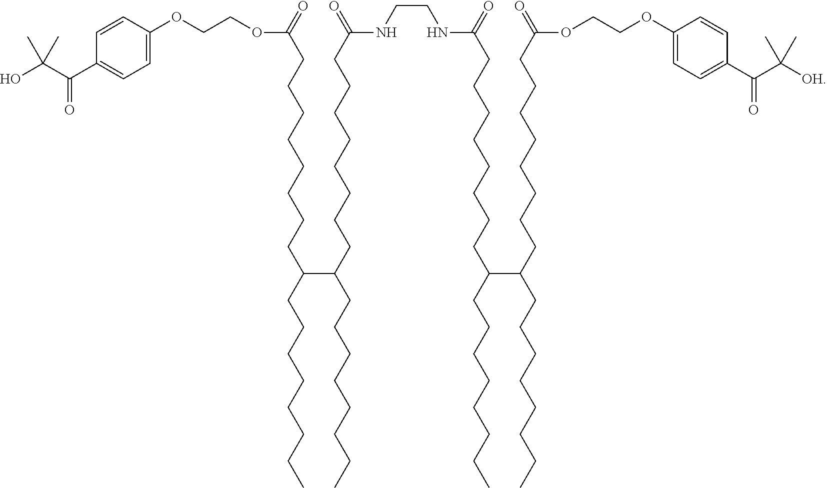

In addition to those gellants disclosed above by U.S. Pat. No. 7,279,687, the gellants of the present embodiments may also be a compound of the formula

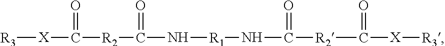

wherein R₁ and R₂ and R₂′ are as described above but wherein at least one of R₃ and R₃′ is an aromatic group, and provided that neither of R₃ and R₃′ is a photointiator group.

In specific embodiments, the gelling agents of the ink are compounds with the following general structures

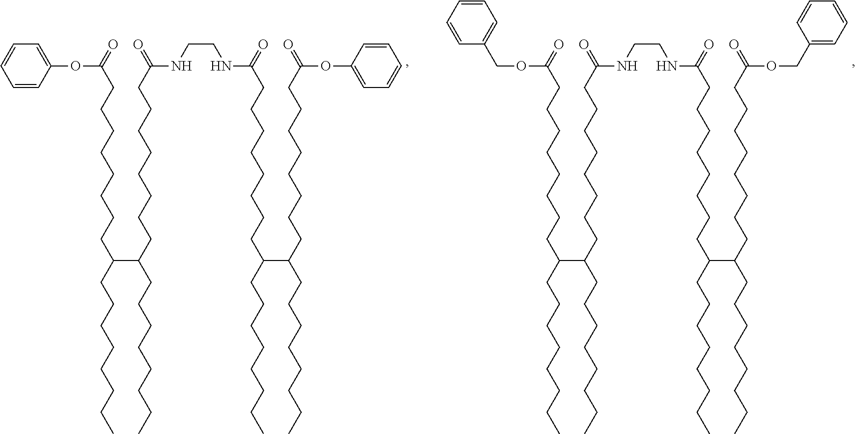

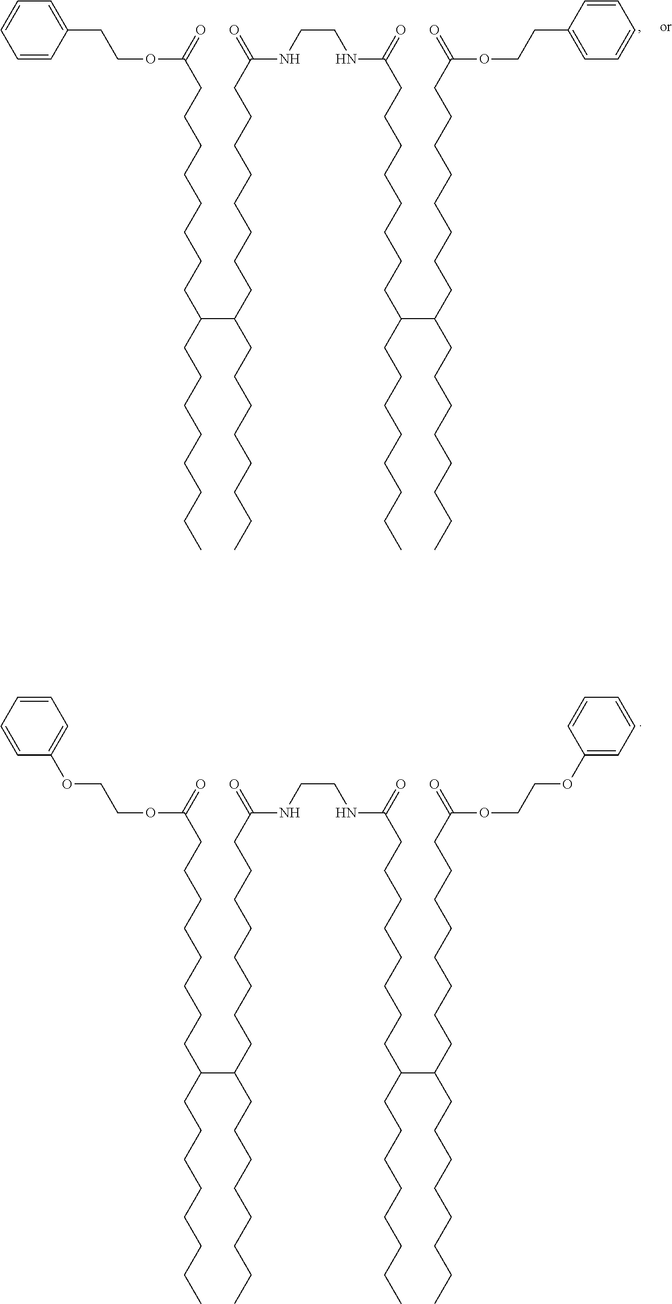

In embodiments, the radiation curable phase change in herein comprises a gellant as described above and optionally a curable wax.

The ink compositions can include the gellant in any suitable amount, such as about 1 percent to about 50 percent or from about 2 percent to

about 20 percent or from about 5 percent to about 15 percent by weight of the ink.

The curable monomer or prepolymer and curable wax together can form more than about 50 percent, or at least 70 percent, or at least 80 percent by weight of the ink.

The ink vehicle of one or more inks of the ink set may contain additional optional additives. Optional additives may include surfactants, light stabilizers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, other non-curable waxes, oils, plasticizers, binders, electrical conductive agents, fungicides, bactericides, organic and/or inorganic filler particles, leveling agents, which are agents that create or reduce different gloss levels, opacifiers, antistatic agents, dispersants, and the like. The inks may include, as a stabilizer, a radical scavenger, such as IRGASTAB UV 10 (Ciba Specialty Chemicals, Inc.). The inks may also include an inhibitor, such as a hydroquinone, to stabilize the composition by prohibiting or, at least, delaying, polymerization of the oligomer and monomer components during storage, thus increasing the shelf life of the composition. However, additives may negatively affect cure rate, and thus care must be taken when formulating a composition using optional additives.

In embodiments, the curable phase change ink compositions described herein also may include a pigment as colorant. Examples of suitable pigments include PALIOGEN Violet 5100 (commercially available from BASF); PALIOGEN Violet 5890 (commercially available from BASF); HELIOGEN Green L8730 (commercially available from BASF); LITHOL Scarlet D3700 (commercially available from BASE); SUNFAST Blue 15:4 (commercially available from Sun Chemical); Hostaperm Blue B2G-D (commercially available from Clariant); Hostaperm Blue B4G (commercially available from Clariant); Permanent Red P-F7RK; Hostaperm Violet BL (commercially available from Clariant); LITHOL Scarlet 4440 (commercially available from BASF); Bon Red C (commercially available from Dominion Color Company); ORACET Pink RE (commercially available from BASF); PALIOGEN Red 3871 K (commercially available from BASF); SUNFAST Blue 15:3 (commercially available from Sun Chemical); PALIOGEN Red 3340 (commercially available from BASF); SUNFAST Carbazole Violet 23 (commercially available from Sun Chemical); LITHOL Fast Scarlet L4300 (commercially available from BASE); SUNBRITE Yellow 17 (commercially available from Sun Chemical); HELIOGEN Blue L6900, L7020 (commercially available from BASF); SUNBRITE Yellow 74 (commercially available from Sun Chemical); SPECTRA PAC C Orange 16 (commercially available from Sun Chemical); HELIOGEN Blue K6902 ₇ , K6910 (commercially available from BASF); SUNFAST Magenta 122 (commercially available from Sun Chemical); HELIOGEN Blue D6840, D7080 (commercially available from BASF); Sudan Blue OS (commercially available from BASE); NEOPEN Blue FF4012 (commercially available from BASF); PV Fast Blue B2GO1 (commercially available from Clariant); IRGALITE Blue BCA (commercially available from BASF); PALIOGEN Blue 6470 (commercially available from BASE); Sudan Orange G (commercially available from Aldrich), Sudan Orange 220 (commercially available from BASF); PALIOGEN Orange 3040 (BASF); PALIOGEN Yellow 152, 1560 (commercially available from BASF); LITHOL Fast Yellow 0991 K (commercially available from BASE); PALIOTOL Yellow 1840 (commercially available from BASF); NOVOPEAM Yellow FGL (commercially available from Clariant); Ink Jet Yellow 4G VP2532 (commercially available from Clariant); Toner Yellow HG (commercially available from Clariant); Lumogen Yellow D0790 (commercially available from BASE); Suco-Yellow L1250 (commercially available from BASF); Suco-Yellow D1355 (commercially available from BASF); Suco Fast Yellow D1355, D1351 (commercially available from BASF); HOSTAPERM Pink E 02 (commercially available from Clariant); Hansa Brilliant Yellow 5GX03 (commercially available from Clariant); Permanent Yellow GRL 02 (commercially available from Clariant); Permanent Rubine L6B 05 (commercially available from Clariant); FANAL Pink D4830 (commercially available from BASF); CINQUASIA Magenta (commercially available from DU PONT); PALIOGEN Black L0084 (commercially available from BASF); Pigment Black K801 (commercially available from BASF); and carbon blacks such as REGAL 330™ (commercially available from Cabot), Nipex 150 (commercially available from Degusssa) Carbon Black 5250 and Carbon Black 5750 (commercially available from Columbia Chemical), and the like, as well as mixtures thereof.

Also suitable are the colorants disclosed in U.S. Pat. No. 6,472,523, U.S. Pat. No. 6,726,755, U.S. Pat. No. 6,476,219, U.S. Pat. No. 6,576,747, U.S. Pat. No. 6,713,614, U.S. Pat. No. 6,663,703, U.S. Pat. No. 6,755,902, U.S. Pat. No. 6,590,082, U.S. Pat. No. 6,696,552, U.S. Pat. No. 6,576,748, U.S. Pat. No. 6,646,111, U.S. Pat. No. 6,673,139, U.S. Pat. No. 6,958,406, U.S. Pat. No. 6,821,327, U.S. Pat. No. 7,053,227, U.S. Pat. No. 7,381,831 and U.S. Pat. No. 7,427,323, the disclosures of each of which are incorporated herein by reference in their entirety.

The pigment may be included in the ink in any suitable amount, such as an amount of from about 0.1 to about 25% by weight of the ink, such as about 0.5 or about 20% to about 1 or about 15% by weight of the ink. The curable phase change inks are solid or solid-like at room temperature. The curable phase change inks are solid or solid-like at room temperature. It is desired for the curable phase change inks to have a viscosity of less than about 50 mPas, such as less than about 30 mPas, for example from about 3 to about 30 mPas, from about 5 to about 20 mPas or from about 8 to about 15 mPas, at the temperature of jetting of the ink. Thus, the inks are jetted in a liquid state, which is achieved by applying heat to melt the ink prior to jetting. The inks are desirably jetted at low temperatures, in particular at temperatures below about 120° C., for example from about 50° C. to about 110° C. or from about 60° C. to about 110° C. The inks are thus ideally suited for use in piezoelectric ink jet devices. The pigment may be added before the ink ingredients have been heated or after the ink ingredients have been heated. When pigments are the selected colorants, the molten mixture may be subjected to grinding in an attritor or ball mill apparatus to effect dispersion of the pigment in the ink carrier. The heated mixture is then stirred for about 5 seconds to about 10 minutes or more, to obtain a substantially homogeneous, uniform melt, followed by cooling the ink to ambient temperature (typically from about 20° C. to about 25° C.). The inks are solid or solid-like at ambient temperature.

The inks can be employed in apparatus for direct printing ink jet processes and in indirect (offset) printing ink jet applications. Another embodiment disclosed herein is directed to a process which comprises incorporating an ink as disclosed herein into an ink jet printing apparatus, melting the ink, and causing droplets of the melted ink to be ejected in an imagewise pattern onto a recording substrate. A direct printing process is also disclosed in, for example, U.S. Pat. No. 5,195,430, the disclosure of which is totally incorporated herein by reference. Yet another embodiment disclosed herein is directed to a process which comprises incorporating an ink as disclosed herein into an ink jet printing apparatus, melting the ink, causing droplets of the melted ink to be ejected in an imagewise pattern onto an intermediate transfer member, and transferring the ink in the imagewise pattern from the intermediate transfer member to a final recording substrate. In a specific embodiment, the intermediate transfer member is heated to a temperature above that of the final recording sheet and below that of the melted ink in the printing apparatus. In another specific embodiment, both the intermediate transfer member and the final recording sheet are heated; in this embodiment, both the intermediate transfer member and the final recording sheet are heated to a temperature below that of the melted ink in the printing apparatus; in this embodiment, the relative temperatures of the intermediate transfer member and the final recording sheet can be (1) the intermediate transfer member is heated to a temperature above that of the final recording substrate and below that of the melted ink in the printing apparatus; (2) the final recording substrate is heated to a temperature above that of the intermediate transfer member and below that of the melted ink in the printing apparatus; or (3) the intermediate transfer member and the final recording sheet are heated to approximately the same temperature. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements. Inks as disclosed herein can also be employed in other hot melt printing processes, such as hot melt acoustic ink jet printing, hot melt thermal ink jet printing, hot melt continuous stream or deflection ink jet printing, and the like. Phase change inks as disclosed herein can also be used in printing processes other than hot melt ink jet printing processes.

Any suitable substrate or recording sheet can be employed, including plain papers such as XEROX 4200 papers, XEROX Image Series papers, Courtland 4024 DP paper, ruled notebook paper, bond paper, silica coated papers such as Sharp Company silica coated paper, JuJo paper, HAMMERMILL LASERPRINT paper, and the like, glossy coated papers such as XEROX Digital Color Gloss, Sappi Warren Papers LUSTROGLOSS, specialty papers such as Xerox DURAPAPER, and the like, transparency materials, fabrics, textile products, plastics, polymeric films, inorganic recording mediums such as metals and wood, and the like, transparency materials, fabrics, textile products, plastics, polymeric films, inorganic substrates such as metals and wood, and the like.

The inks described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

Rheology Studies

A study was conducted to determine the optimum levels of epoxidized soybean oil acrylate monomer loading in the inks of the present embodiments which still retained the desirable jettable viscosity required by a UV ink printer. As shown in the FIGURE, which illustrates a rheology plot of complex viscosity versus temperature of several prepared cyan inks of the present embodiments, suitable ink formulations comprise up to 25 percent by weight of the epoxidized soybean oil acrylate monomer.

Preparation of Solid Inks

Various UV curable phase-change ink compositions incorporating epoxidized oil-based acrylates were prepared as follows: to a 30 mL amber glass bottle heated to 90° C. was added SR9003 monomer, a propoxylated neopentyl glycol diacrylate available from Sartomer Company (Exton, Pa.), IRGACURE 379. 819, and 1.27, photoinitiators available from BASF Specialty Chemicals (Basel, Switzerland), and IRGASTAB UV10, stabilizer that acts as a effective radical scavenger to prevent gelation of UV curable compositions while having minimal impact on curing speed, also available from BASF Specialty Chemicals. The mixture was heated with stirring until the solid components were dissolved. Next, UNILIN 350 acrylate, an acrylate-modified wax based on UNILIN 350, available from Baker Petrolite (Houston, Tex.) and the epoxidized oil acrylate of interest (epoxidized soybean oil acrylate, from Aldrich Chemicals, abbreviated as ESOA) were added to the mixture. The mixture was heated with stirring for 1 hour to complete the ink base preparation. Finally, a pigment dispersion concentrate in SR9003 was added, and the mixture was stirred for 1 hour more. The formulations of the prepared inks are shown in Table 1. Phenyl glycol capped amide gellant was used in all examples, and added at the same time as the diluents monomer SR9003.

TABLE 1

| | | | | Ink D |
|---|---|---|---|---|
| Component | Ink A | Ink B | Ink C | (prophetic) |
| Wax | UNILIN 350 | UNILIN 350 | UNILIN 350 | UNILIN 350 |
| | Acrylate | Acrylate | Acrylate | Acrylate |
| Amide Gellant | Phenyl | Phenyl | Phenyl | Phenyl |
| | glycol | glycol | glycol | glycol |
| | capped | capped | capped | capped |
| | amide | amide | amide | amide |
| | gellant | gellant | gellant | gellant |
| Monomer | SR9003 | SR9003 | SR9003 | SR9003 |
| ESOA | Epoxidized | Epoxidized | Epoxidized | Epoxidized |
| | soybean oil | soybean oil | soybean oil | linseed oil |
| | acrylate | acrylate | acrylate | acrylate |
| | (5%) | (10%) | (20%) | (25%) |
| Photoinitiators | IRGACURE | IRGACURE | IRGACURE | IRGACURE |
| | 379, 819 and | 379, 819 and | 379, 819 and | 379, 819 and |
| | 127 | 127 | 127 | 127 |
| Stabilizer | IRGASTAB | IRGASTAB | IRGASTAB | IRGASTAB |
| | UV10 | UV10 | UV10 | UV10 |
| Colorant | 15 wt % | 15 wt % | 15 wt % | 15 wt % |
| | cyan | cyan | cyan | cyan |
| | pigment | pigment | pigment | pigment |
| | dispersion in | dispersion in | dispersion in | dispersion in |
| | SR9003 | SR9003 | SR9003 | SR9003 |
| Total | 100% | 100% | 100% | 100% |

In Table 1, the prepared inks vary in amounts of epoxidized oil acrylate used in the formulation. For example, Ink A comprises 5 percent by weight of the epoxidized oil acrylate, Ink B comprises 10 percent by weight of the epoxidized oil acrylate, Ink C comprises 20 percent by weight of the epoxidized oil acrylate and prophetic example Ink D comprises 25 percent by weight of the epoxidized oil acrylate.

Test Results

Inks A, B and C were printed on uncoated Mylar sheets using a K-printing proofer and cured with a 600 W Fusions UV Lighthammer UV curing lamp fitted with a mercury D-bulb under a moving conveyor belt moving at 32 fpm. The cured films were subjected to methyl ethyl ketone (MEK) double rubs with a cotton swab to evaluate cure. Table 2 below summarizes the film MEK rub resistance properties of the present embodiments. As can be seen, performance of inks comprising the ESOA over a range of percentages has rub resistance comparable to the acceptable standard.

TABLE 2

| Sample | ESOA (%) | MEK double rubs |
|---|---|---|
| Ink A | 5 | 52 |
| Ink B | 10 | 30 |
| Ink C | 20 | 16 |

### SUMMARY

In summary, the present embodiments provide curable solid inks that retain the advantages of handling and safety associated with solid, phase change inks but provide additional benefits of being based on monomers derived from renewable and environmentally-friendly sources. In particular, the UV curable ink compositions o the present embodiments are based on epoxidized oil-based diacrylates as bio-based monomer/oligomer additives.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A curable solid ink comprising:
a curable wax;
one or more monomers;
an amide gellant;
a photoinitiator; and
colorant comprising a dispersion of a cyan pigment in propoxylated neopentyl glycol diacrylate, wherein the one or more monomers comprises a product of a reaction where an unsaturated oil having one or more epoxy groups has been functionalized by acrylic acid.

2. The curable solid ink of claim 1, wherein the product of the reaction is an epoxidized oil acrylate.

3. The curable solid ink of claim 2, wherein the epoxidized oil acrylate is selected from the group consisting of epoxidized soybean oil acrylate, epoxidized castor oil acrylate, epoxidized linseed oil acrylate, epoxidized rapeseed oil acrylate, and mixtures thereof.

4. The curable solid ink of claim 1, wherein the epoxidized oil acrylate is present in an amount of from about 1 to about 25 percent by weight of the total weight of the curable solid ink.

5. The curable solid ink of claim 4, wherein the epoxidized oil acrylate is present in an amount of from about 2 to about 20 percent by weight of the total weight of the curable solid ink.

6. The curable solid ink of claim 5, wherein the epoxidized oil acrylate is present in an amount of from about 5 to about 10 percent by weight of the total weight of the curable solid ink.

7. The curable solid ink of claim 1, wherein the one or more monomers further comprises propoxylated neopentyl glycol diacrylate.

8. The curable solid ink of claim 1, wherein the curable wax is present in an amount of from about 2 to about 10 percent by weight of the total weight of the curable solid ink.

9. The curable solid ink of claim 1, wherein the curable wax is selected from the group consisting of acrylate modified hydroxyl-terminated polyethylene wax, behenyl acrylate, octadecyl acrylate, acrylated C₁₂ linear alcohols, and mixtures thereof.

10. The curable solid ink of claim 1, wherein the amide gellant is present in an amount of from about 2 to about 25 percent by weight of the total weight of the curable solid ink.

11. The curable solid ink of claim 10, wherein the amide gellant is present in an amount of from about 4 to about 12 percent by weight of the total weight of the curable solid ink.

12. The curable solid ink of claim 1, wherein the amide gellant is a phenyl glycol capped amide gellant.

13. The curable solid ink of claim 1, wherein the photoinitiator is present in an amount of from about 1 to about 15 percent by weight of the total weight of the curable solid ink.

14. The curable solid ink of claim 13, wherein the photoinitiator is present in an amount of from about 6 to about 15 percent by weight of the total weight of the curable solid ink.

15. The curable solid ink of claim 1, wherein the photoinitiator is selected from the group consisting of alpha-hydroxy ketones, mono-acyl phosphine oxides, bis-acyl phosphine oxides, and the like, and mixtures thereof.

16. The curable solid ink of claim 1, wherein the colorant is present in an amount of from about 0.5 to about 50 percent by weight of the total weight of the curable solid ink.

17. The curable solid ink of claim 16, wherein the colorant is present in an amount of from about 15 to about 25 percent by weight of the total weight of the curable solid ink.

18. (canceled)

19. (canceled)

20. A curable solid ink comprising:
a curable wax;
one or more monomers;
an amide gellant;
a photoinitiator; and
colorant comprising a dispersion of a pigment in propoxylated neopentyl glycol diacrylate, wherein the one or more monomers comprises an epoxidized compound having the structure:

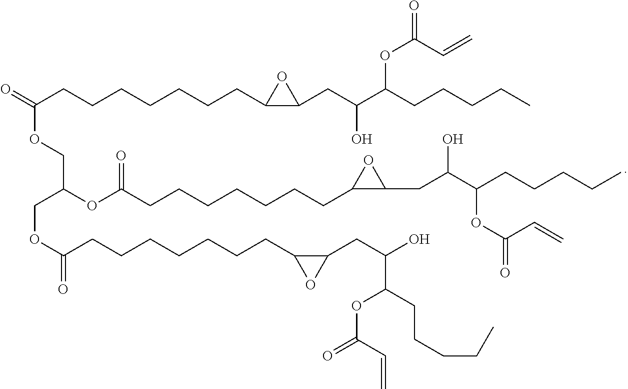

21. A curable solid ink comprising:
a curable wax;
one or more monomers;
an amide gellant;
a photoinitiator; and
an optional colorant comprising a dispersion of a pigment in propoxylated neopentyl glycol diacrylate, wherein the one or more monomers comprises an epoxidized oil acrylate obtained from a reaction of an epoxidized oil with acrylic acid such that some or all of the epoxide groups are ring-opened and acrylate groups are incorporated into the backbone structure.
